(19) United States
(12) Patent Application Publication
(10) Pub. No.: US 2013/0180372 A1
(43) Pub. Date: Jul. 18, 2013

(54) PROCESSING METHOD OF CHANNELS IN CONTROL VALVE

(71) Applicant: Shih-Wei Chiu, Changhua (TW)

(72) Inventor: Shih-Wei Chiu, Changhua (TW)

(73) Assignee: TENNEY METAL WORKS CO., LTD., CHANGHUA (TW)

(21) Appl. No.: 13/351,427

(22) Filed: Jan. 17, 2012

(51) Int. Cl. B26F 1/16

(52) U.S. Cl. 83/30

(57) ABSTRACT

A processing method of channels in a control valve includes steps of (1) preparing materials, which provides a valve base having a connecting portion protrudingly formed at outer periphery of a first pressure chamber, and an enlarging portion expandingly formed downward from the connecting portion; and (2) manufacturing channels, wherein a vertical channel is formed from upper portion of the connecting portion of the valve base to the enlarging portion, and a horizontal channel is formed from periphery of the first pressure chamber slantedly toward the enlarging portion. The valve base can be adjusted by adjusting a disposing angle, so that a drill head can drill slantedly from periphery of the first pressure chamber toward the enlarging portion without being interfered by an opening of the valve base, to achieve the goal of connecting the vertical channel without drilling through valve body of the valve base to assure completeness thereof.

### FIELD OF THE INVENTION

The present invention relates to a processing method of channels in a control valve, and more particularly to a processing method having a connecting portion of a valve base forming an enlarging portion downwards, so when a horizontal channel of the valve base is manufactured, it slantedly drills from the periphery of a first pressure chamber to the enlarging portion to achieve the goal of connecting a vertical channel without drilling through the valve body of the valve base to assure the completeness of the valve base. Therefore, when the valve base sustains repeated pressure changes, the valve base can maintain the airtightness thereof to increase the durability of the product.

### BACKGROUND OF THE INVENTION

Referring to FIG. 8 for a conventional control valve including a base (30), a cover (40), wherein the base (30) has a back pressure chamber (31) with an upwards opening, and the back pressure chamber (31) has a horizontal channel (311) disposed through periphery thereof and connecting to outside, and the horizontal channel (311) provides a plug (312) outside. A vertical channel (313) is formed on the opening of the base (30), connecting with the horizontal channel (311). A space (32) is formed through the opening of the back pressure chamber (31). The cover (40) covers the base (30), having a front pressure chamber (41) with a downward opening, and a membrane piece (42) is disposed between the front pressure chamber (41) and the back pressure chamber (31). A valve rod (421) is connected with the membrane piece (42), and the valve rod (421) is disposed in the space (32) of the base (30). A receiving space (43) is recessedly formed at the vertical channel (313) of the base (30) corresponding to the cover (40), and the receiving space (43) has two through holes (431) are connected to the front pressure chamber (41) and the vertical channel (313) of the base (30), respectively. An electro-magnetic valve (44) is disposed in the receiving space (43), connecting two through holes (431) to control the pressure difference between the back pressure chamber (31) and the front pressure chamber (41), to further drive the valve rod (421) with the membrane piece (42).

According to the structure of the conventional water spray gun, it is disadvantageous that when the horizontal channel (311) of the base (30) is processed, it drills from outside of the valve body to the back pressure chamber (31), and the plug (312) is disposed to seal from an outer portion of the horizontal channel (311). Therefore, when the horizontal channel (311) and the vertical channel (313) of the base (30) sustain repeated pressure changes, the plug (312) may separate from the base (30) to lose the airtightness. It adversely affects the durability of the product.

### SUMMARY OF THE INVENTION

The problem to be solved in the present invention is that when the horizontal channel of the base is processed, it drills from outside of the valve body to the back pressure chamber, and the plug is disposed to seal from an outer portion of the horizontal channel. Therefore, when the horizontal channel and the vertical channel of the base sustain repeated pressure changes, the plug may separate from the base to lose the airtightness. It adversely affects the durability of the product.

The present invention provides a processing method of channel in a control valve, including steps of (1) preparing materials; and (2) manufacturing channels, wherein the step of preparing materials provides a valve base that has a first pressure chamber with an upward opening, and a through space is formed at an opening surface of the first pressure chamber, and a connecting portion is protrudingly formed at a periphery of the first pressure chamber. An enlarging portion is expandingly formed downward from the connecting portion. The step of manufacturing channels provides a drill head from the connecting portion of the valve base toward the enlarging portion to form a vertical channel. A horizontal channel is formed from a periphery of the first pressure chamber slantedly toward the enlarging portion, and the horizontal channel and the vertical channel are connected. Since the connecting portion has the enlarging portion at a lower portion thereof, the valve base can be adjusted by adjusting a disposing angle, so that the drill head can drill slantedly from the periphery of the first pressure chamber toward the enlarging portion without being interfered by the opening of the valve base, to achieve the goal of connecting the vertical channel. Also, the body of the valve base will not be drilled through to assure the completeness of the valve base.

Comparing with conventional control valves, the present invention provides a processing method of channels in a control valve having a connecting portion of a valve base forming an enlarging portion downwards, so when the horizontal channel of the valve base is manufactured, it slantedly drills from the periphery of a first pressure chamber to the enlarging portion to achieve the goal of connecting the vertical channel without drilling through the valve body of the valve base to assure the completeness of the valve base. Therefore, when the valve base sustains repeated pressure changes, the valve base can maintain the airtightness thereof to increase the durability of the product.

### BRIEF DESCRIPTION OF THE DRAWINGS

FIG. 1 illustrates a manufacturing process flow diagram in the present invention.

FIG. 2 illustrates a three-dimensional view in the present invention.

FIG. 3 illustrates a schematic sectional view in the present invention.

FIG. 4 illustrates a schematic view of the process of drilling the vertical channel the present invention.

FIG. 5 illustrates a schematic view of the process of drilling the horizontal channel the present invention.

FIG. 6 illustrates a three-dimensional assembled view of the present invention when in use.

FIG. 7 illustrates a schematic sectional view of the present invention when in use.

FIG. 8 illustrates a schematic sectional view of prior arts.

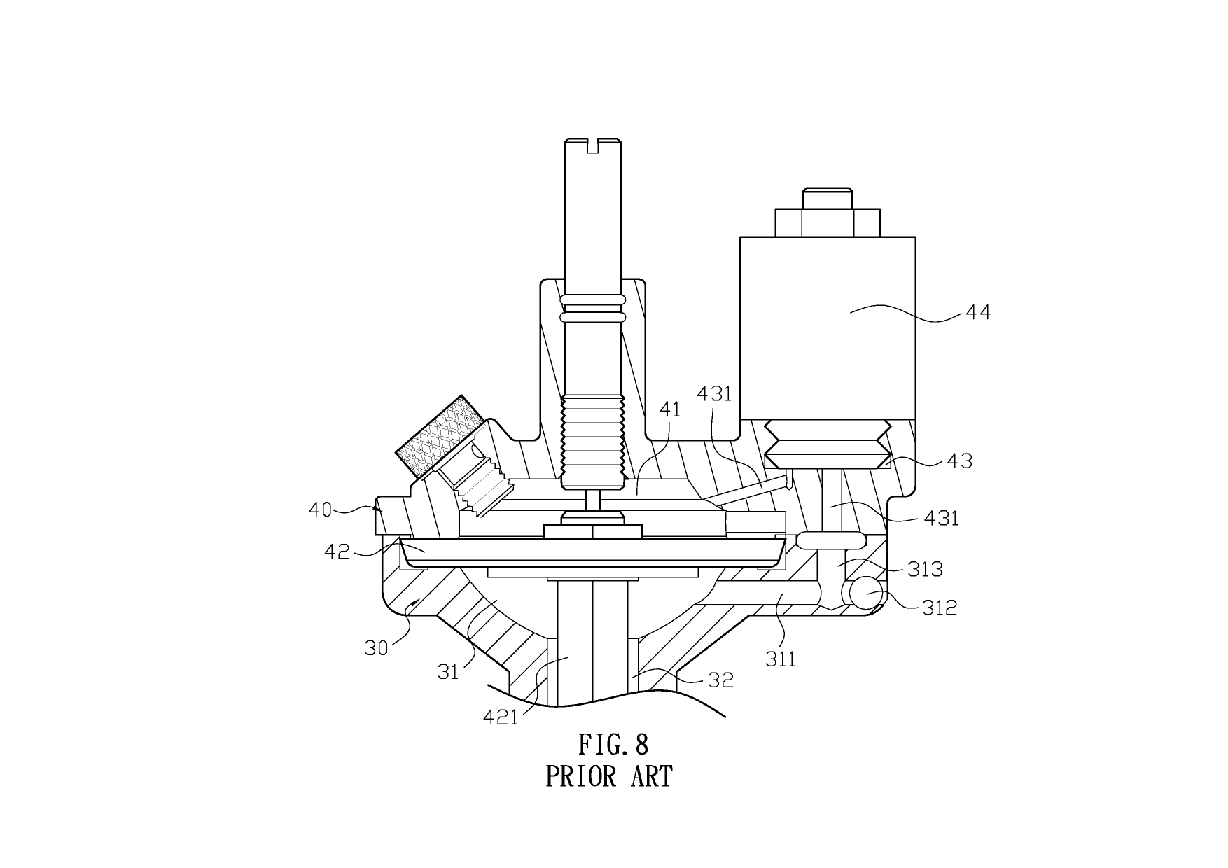

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

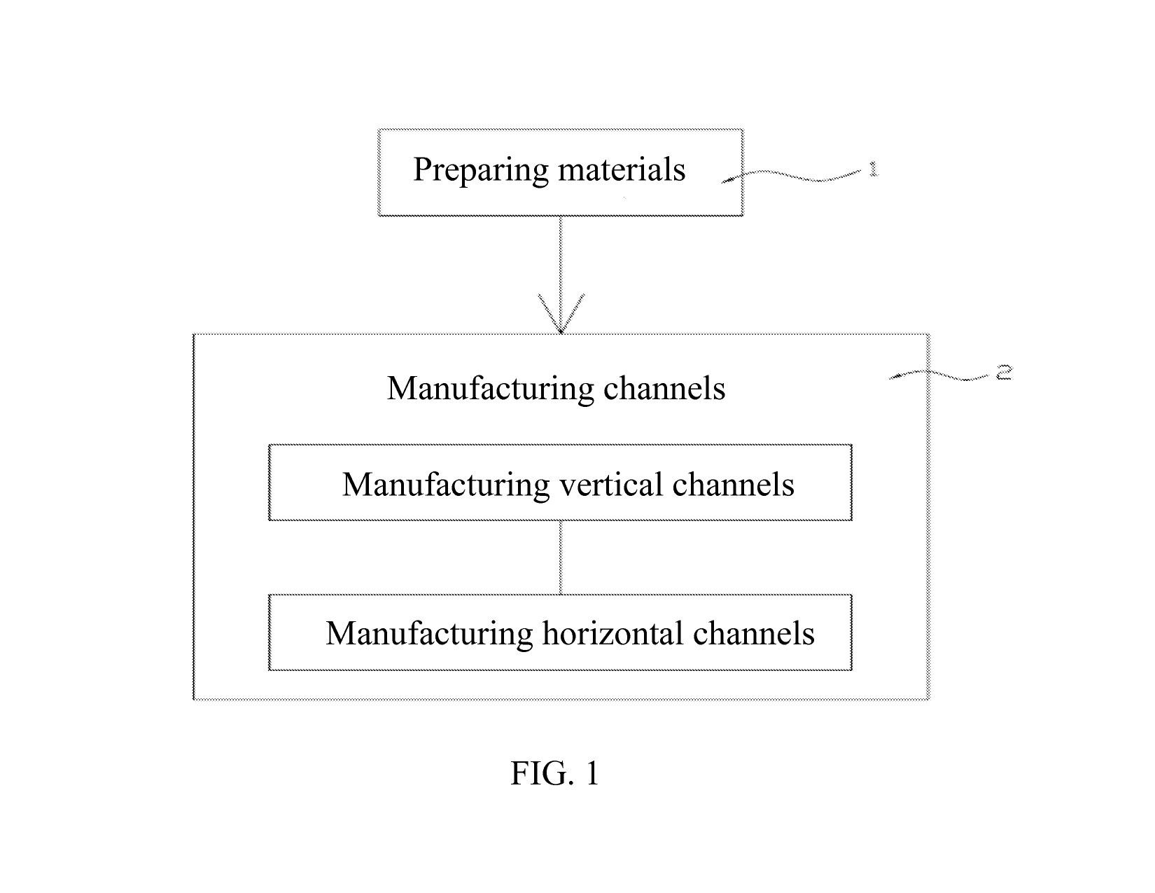

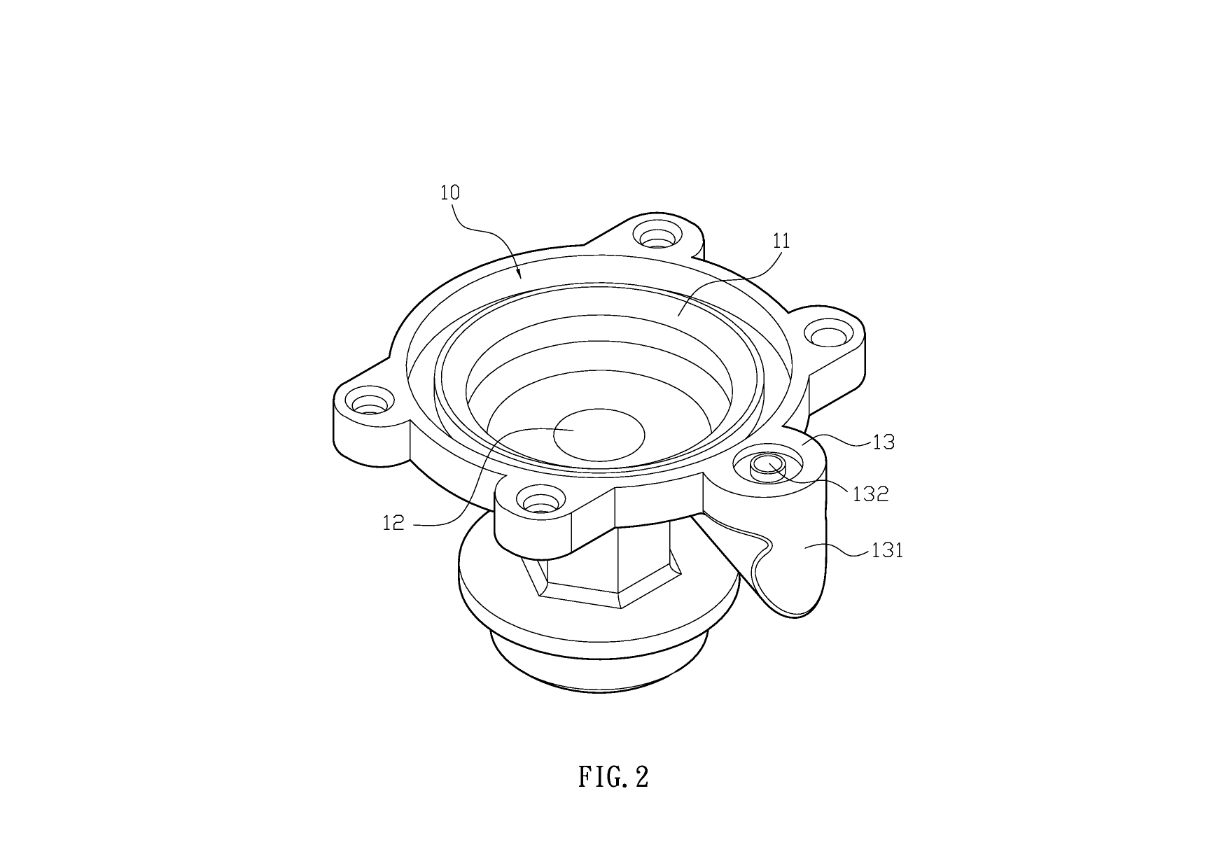

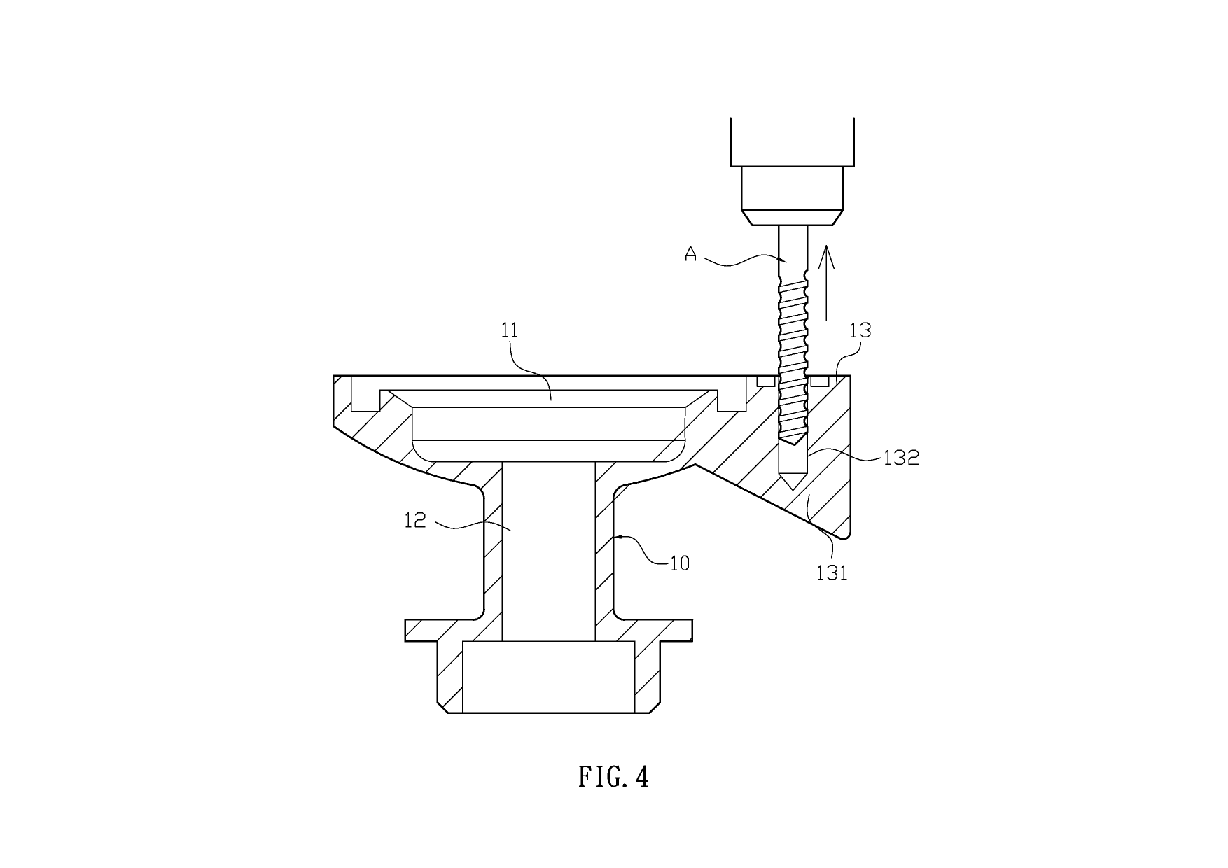

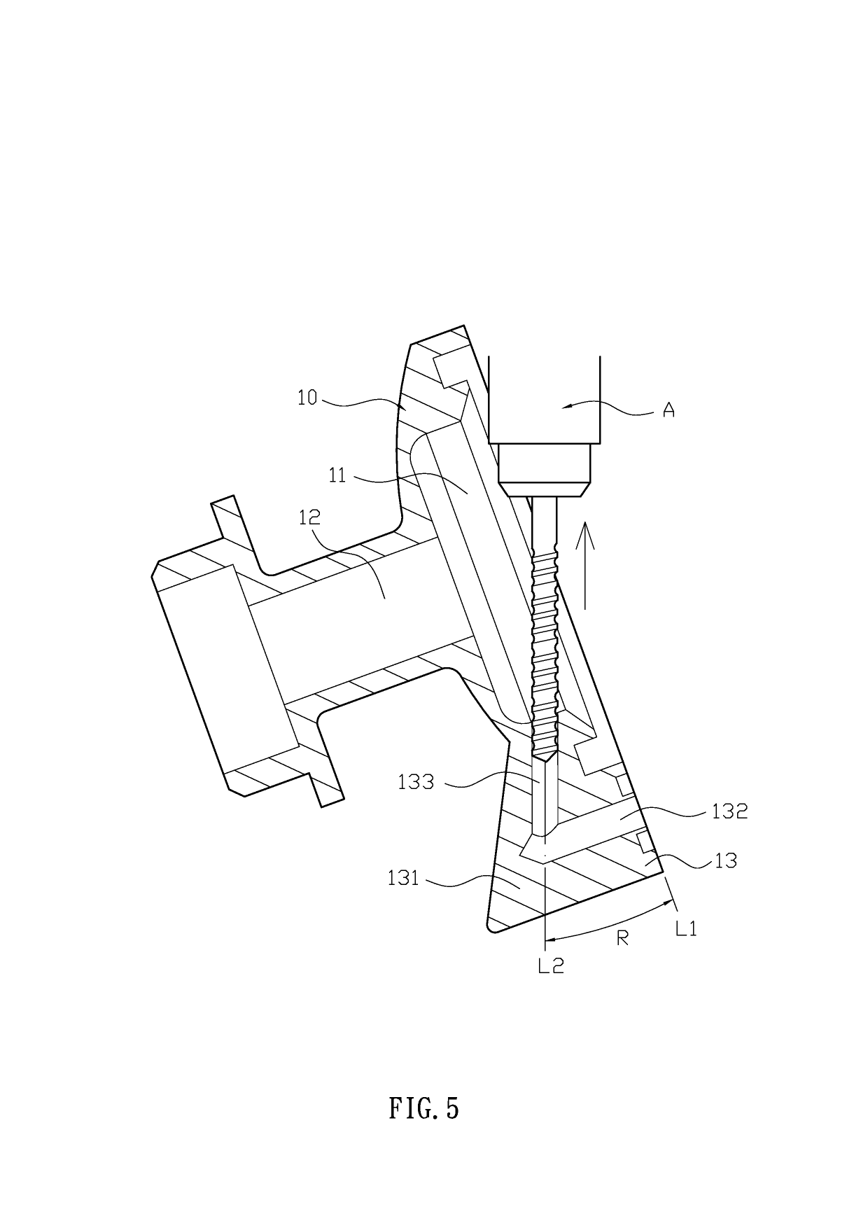

Referring to FIGS. 1 to 3, a processing method of a channel in a control valve includes steps of (1) preparing materials; and (2) manufacturing channels, wherein the step of preparing materials provides a valve base (10) that has a first pressure chamber (11) with an upward opening. A through space (12) is formed at an opening surface of the first pressure chamber (11), and a connecting portion (13) is protrudingly formed at a periphery of the first pressure chamber (11). An enlarging portion (131) is expandingly formed downward from the connecting portion (13). The step of manufacturing channels provides a drill head (A) from the connecting portion (13) of the valve base (10) toward the enlarging portion (131) to form a vertical channel (132) (see FIG. 4 as well). A horizontal channel (133) is formed from a periphery of the first pressure chamber (11) slantedly toward the enlarging portion (131), and the horizontal channel (133) and the vertical channel (132) are connected. Since the connecting portion (13) has the enlarging portion (131) at a lower portion thereof, the valve base (10) can be adjusted by adjusting a disposing angle, so that the drill head (A) can drill slantedly from the periphery of the first pressure chamber (11) toward the enlarging portion (131) without being interfered by the opening of the valve base (10), to achieve the goal of connecting the vertical channel (132) (see FIG. 5 as well). Also, the valve base (10)'s body will not be drilled through to assure the complete structure of the valve base (10).

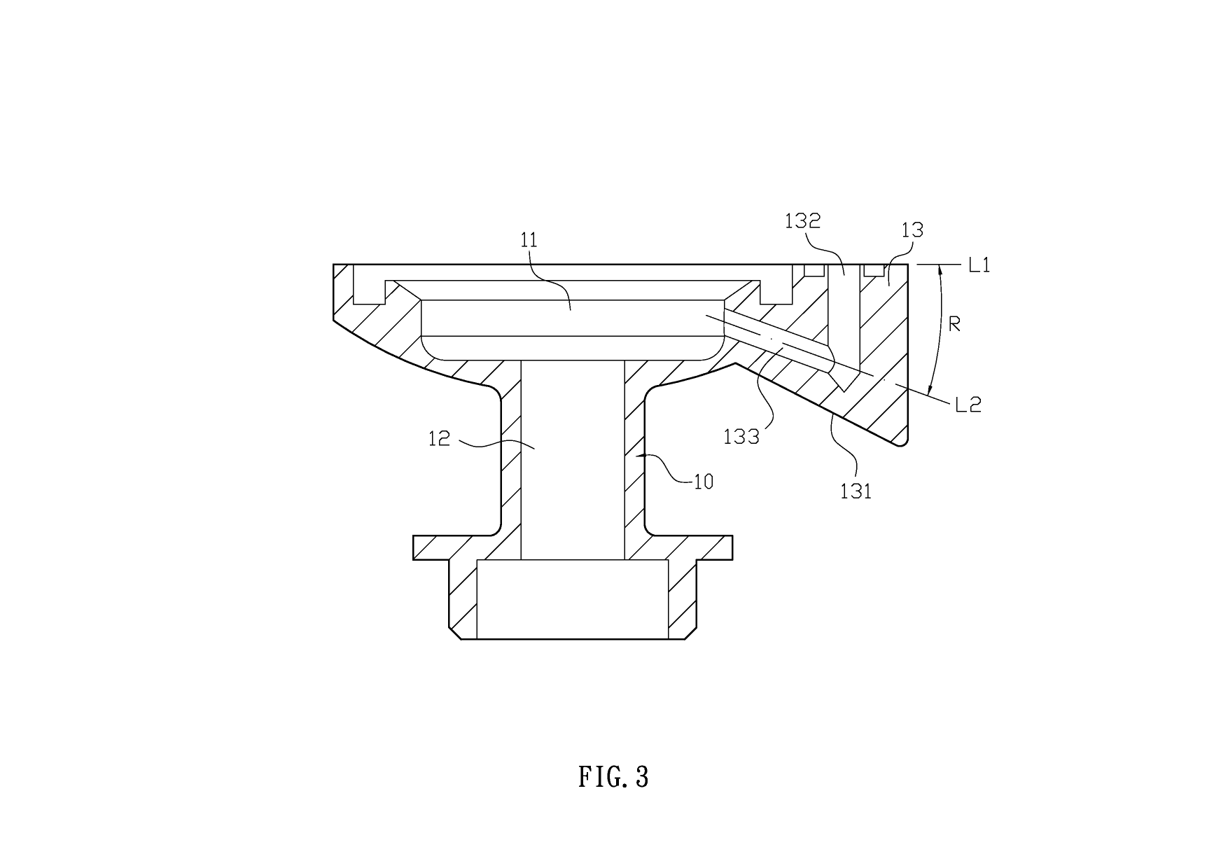

Still referring to FIG. 3 to further illustrate the structure of the present invention, the opening of the valve base (10) has a horizontal extension line (L1), and the horizontal channel (133) has a central axial line (L2) to form an angle (R) with the horizontal extension line (L1). The angle (R) is between 15 and 25 degrees to assure that the horizontal channel (133) and the vertical channel (132) are connected.

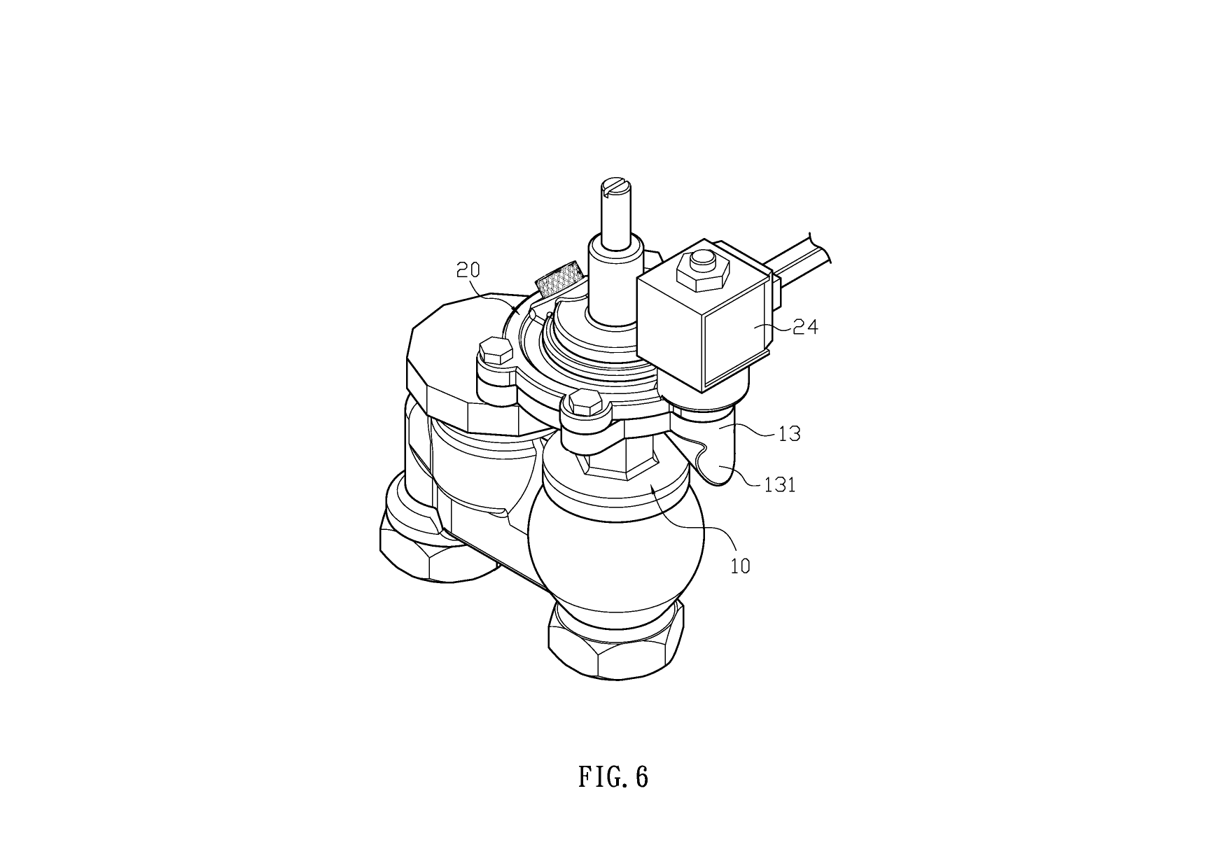

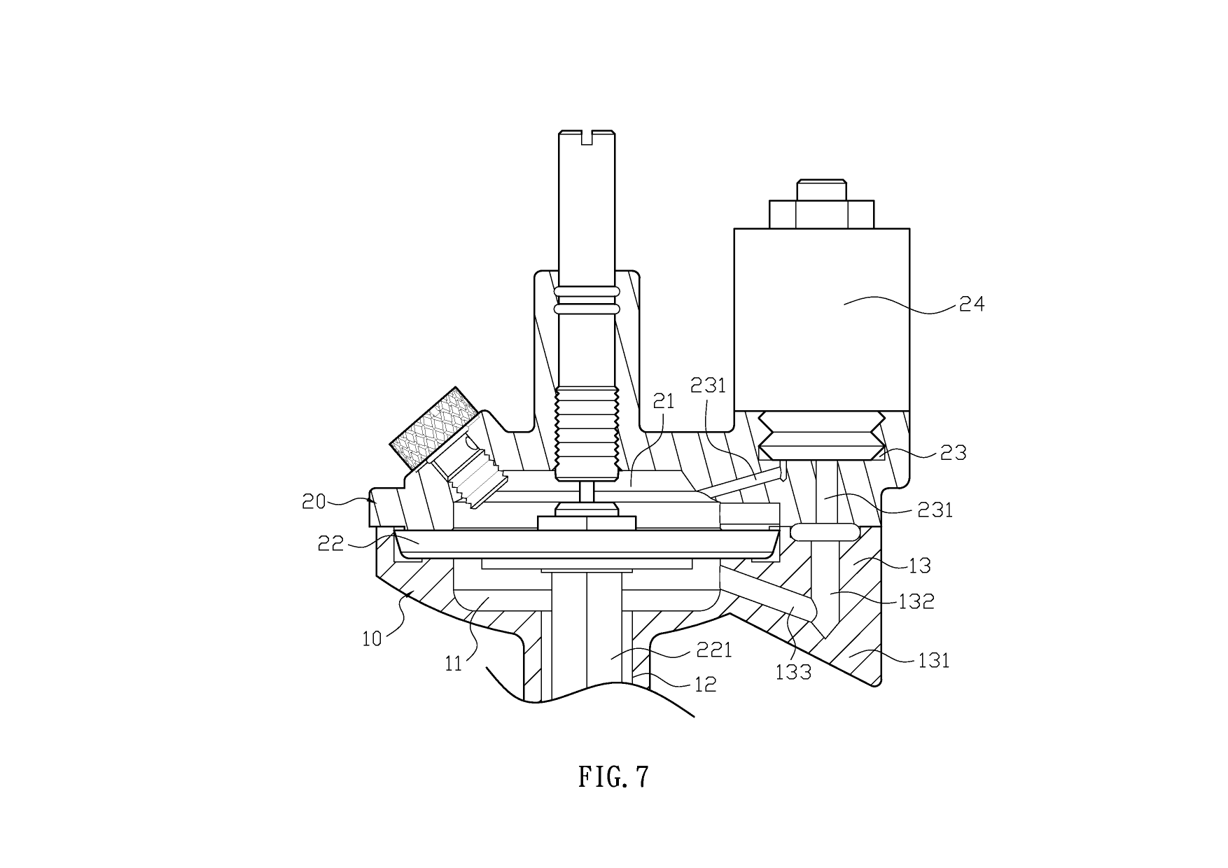

Referring to FIGS. 6 and 7 for another embodiment in the present invention, the valve base (10) has a valve cover (20) that has a second pressure chamber (21), and a membrane (22) is disposed between the chamber (21) and the first pressure chamber (11) of the valve base (10). The membrane (22) has a valve stick (221) that is located in the through space (12) of the valve base (10). A receiving space (23) that has an upward opening is recessedly formed at the connecting portion (13) of the valve base (10) corresponding to the valve cover (20), and the receiving space (23) has two connecting holes (231) connecting with the second pressure chamber (21) and the vertical channel (132) of the valve base (10). Also, the receiving space (23) has a electro-magnetic valve (24) connecting with two connecting holes (231) to control the pressure difference between the first pressure chamber (11) and the second pressure chamber (21), to further let the membrane (22) drive the valve stick (221). Since the horizontal channel (133) does not pass through the valve body of the valve base (10) during manufacturing process to assure the completeness of the structure of the valve base (10), the valve base (10) can maintain the airtightness thereof when the pressure changes repeatedly to further increase the durability of the product.

According to the embodiment stated above, the present invention is advantageous that the connecting portion (13) of the valve base (10) forms the enlarging portion (131) downwards, so when the horizontal channel of the valve base (10) is manufactured, it slantedly drills from the periphery of the first pressure chamber (11) to the enlarging portion (131) to achieve the goal of connecting the vertical channel (132) without drilling through the valve body of the valve base (10) to assure the completeness of the valve base (10). Therefore, when the valve base (10) sustains repeated pressure changes, the valve base (10) can maintain the airtightness thereof to increase the durability of the product.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A processing method of channels in a control valve comprising steps of:
preparing materials, wherein a valve base is provided that has a first pressure chamber with an upward opening, and a through space is formed at an opening surface of the first pressure chamber, and a connecting portion is protrudingly formed at a periphery of the first pressure chamber, and an enlarging portion is expandingly formed downward from the connecting portion; and
manufacturing channels, wherein a vertical channel is formed from an upper portion of the connecting portion of the valve base to the enlarging portion, and a horizontal channel is formed from a periphery of the first pressure chamber slantedly toward the enlarging portion, and the horizontal channel and the vertical channel are connected, wherein the connecting portion has the enlarging portion at a lower portion thereof, and the valve base is allowed to be adjusted by adjusting a disposing angle, so that a drill head is able to drill slantedly from the periphery of the first pressure chamber toward the enlarging portion without being interfered by an opening of the valve base, to achieve the goal of connecting the vertical channel without drilling through a valve body of the valve base to assure completeness thereof.

2. The processing method of claim 1, wherein the opening of the valve base has a horizontal extension line, and the horizontal channel has a central axial line to form an angle with the horizontal extension line, and the angle is between 15 and 25 degrees.

3. The processing method of claim 1, wherein the valve base has a valve cover that has a second pressure chamber, and a membrane is disposed between the chamber and the first pressure chamber of the valve base, and the membrane has a valve stick that is located in the through space of the valve base, wherein a receiving space that has an upward opening is recessedly formed at the connecting portion of the valve base corresponding to the valve cover, and the receiving space has two connecting holes connecting with the second pressure chamber and the vertical channel of the valve base, and the receiving space has a electro-magnetic valve connecting with two connecting holes to control the pressure difference between the first pressure chamber and the second pressure chamber.
